(19) United States
(12) Patent Application Publication
(10) Pub. No.: US 2026/0295544 A1
(43) Pub. Date: Oct. 1, 2026

(54) STIRRING BLADE AND STIRRING DEVICE INCLUDING STIRRING BLADE

(71) Applicant: MITSUBISHI HEAVY INDUSTRIES, LTD., Tokyo (JP)

(72) Inventors: Keiichi NAKAGAWA, Tokyo (JP); Keiji FUJIKAWA, Tokyo (JP); Takashi IKEDA, Tokyo (JP); Shunsuke TABA, Tokyo (JP)

(21) Appl. No.: 18/996,267

(22) PCT Filed: Feb. 22, 2023
(86) PCT No.: PCT/JP2023/006364

§ 371 Date: Jan. 17, 2025

(30) Foreign Application Priority Data
Aug. 25, 2022 (JP) 2022-133727

(51) Int. Cl. B01F 27/112; B01F 27/07; B01F 27/70; B01F 35/33; B01F 35/45; B01F 35/75

(52) U.S. Cl. CPC B01F 27/112; B01F 27/071; B01F 27/70; B01F 35/332; B01F 35/45; B01F 35/7547; B01F 2215/0427

(57) ABSTRACT

In a stirring blade including: a support rod; and a blade part attached to the support rod and extending so as to have a longitudinal axis in a direction intersecting the length direction of the support rod, the blade part includes two opposite surfaces, the blade part at least partially includes a portion where one surface of the two surfaces is inclined with respect to the other surface, and in said portion, the thickness of the blade part decreases from one side to the other side along the longitudinal axis.

### TECHNICAL FIELD

The present disclosure relates to a stirring blade and a stirring device including the stirring blade.

The present application claims priority based on Japanese Patent Application No. 2022-133727 filed on Aug. 25, 2022, the entire content of which is incorporated herein by reference.

### BACKGROUND ART

Patent document 1 mentions a horizontal reactor with a stirrer having one or more stirring blades in the horizontal direction. Examples include one with a paddle having a scraper at the tip end of the stirring shaft as a stirring blade to expand the surface area of the reaction mixture and to reduce the stagnant area.

### CITATION LIST

### Patent Literature

Patent Document 1: JP4836299B

### SUMMARY

### Problems to be Solved

In a stirring device provided with a container incorporating a stirring blade, the discharging hole for discharging the contents is small compared to the size of the container. Therefore, since the stirring blade used to improve the stirring efficiency of the contents, as in Patent Document 1, does not have the function of efficiently discharging the contents from the container, the container is designed to make it easier to discharge the contents by tilting the container and placing the discharging hole in the lowest position of the container, for example.

In view of the above, an object of at least one embodiment of the present disclosure is to provide a stirring blade capable of efficiently discharging the contents and a stirring device including the stirring blade.

### Solution to the Problems

In order to achieve the above object, a stirring blade of the present disclosure includes: a support rod; and a blade part attached to the support rod and extending so as to have a longitudinal axis in a direction intersecting the length direction of the support rod. The blade part includes two opposite surfaces, the blade part at least partially includes a portion where one surface of the two surfaces is inclined with respect to the other surface, and in said portion, the thickness of the blade part decreases from one side to the other side along the longitudinal axis.

### Advantageous Effects

With the stirring blade of the present disclosure, by attaching the stirring blade such that one of the two surfaces of the blade part is inclined with respect to a rotational shaft to which the stirring blade is fixed, the contents in the stirring device move along the inclination of the one surface when stirring the contents by the stirring blade, and as a result, the contents can be moved in the direction along the rotational shaft. Therefore, if the discharging hole is positioned in the direction of movement of the contents, the contents can be efficiently discharged by rotating the stirring blade.

### BRIEF DESCRIPTION OF DRAWINGS

FIG. 1 is a schematic view showing the configuration of a stirring device according to an embodiment of the present disclosure.

FIG. 2 is a cross-sectional view taken along line II-II in FIG. 1.

FIG. 3 is a front view of a stirring blade according to an embodiment of the present disclosure.

FIG. 4 is a plan view of a stirring blade according to an embodiment of the present disclosure.

FIG. 5 is a cross-sectional view of a blade part of a stirring blade according to another embodiment of the present disclosure.

FIG. 6 is a front view of a stirring blade according to still another embodiment of the present disclosure.

FIG. 7 is a front view of a stirring blade according to still another embodiment of the present disclosure.

FIG. 8 is a cross-sectional view of a stirring blade according to still another embodiment of the present disclosure.

FIG. 9 is a cross-sectional view of a stirring blade according to still another embodiment of the present disclosure.

FIG. 10 is a cross-sectional view of a stirring blade according to still another embodiment of the present disclosure.

FIG. 11 is a plan view of a stirring blade according to still another embodiment of the present disclosure.

FIG. 12 is a cross-sectional view of a stirring blade according to still another embodiment of the present disclosure.

FIG. 13 is a front view for describing the configuration of the stirring blade according to some embodiments of the present disclosure.

FIG. 14 is an enlarged view of the stirring blade in the vicinity of the inner wall surface of the container of the stirring device according to an embodiment of the present disclosure.

FIG. 15 is an explanatory view for describing the configuration of a first stirring blade in the container of the stirring device according to an embodiment of the present disclosure.

FIG. 16 is an explanatory view for describing the configuration of a second stirring blade in the container of the stirring device according to an embodiment of the present disclosure.

### DETAILED DESCRIPTION

Hereinafter, a stirring blade according to embodiments of the present disclosure will be described with reference to the drawings. The embodiment to be described below indicates one aspect of the present disclosure, does not intend to limit the disclosure, and can optionally be modified within a range of a technical idea of the present disclosure.

### Configuration of Stirring Device According to One Embodiment of Present Disclosure

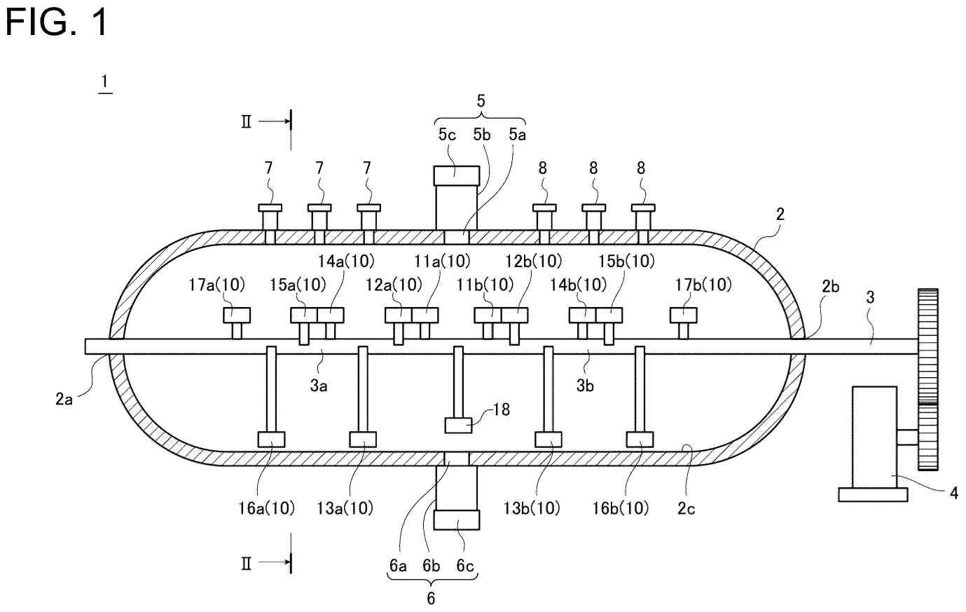

As shown in FIG. 1, a stirring device 1 according to an embodiment of the present disclosure includes a container 2 of horizontally elongated shape, a rotational shaft 3 provided to penetrate the container 2 in the horizontal direction, and at least one, preferably two or more, stirring blades 10 fixed to the rotational shaft 3. The rotational shaft 3 is configured to rotate by a motor 4, which is a rotating device. The motor 4 is preferably configured to be able to switch the direction of rotation of the rotational shaft 3. In other words, the motor 4 is preferably equipped with a switching device to switch the direction of rotation of the rotational shaft 3. The switching device may, for example, be a device that reverses the current flowing in the motor 4 to reverse the direction of rotation of the motor 4, or a device that reverses the direction of rotation transmitted from the motor 4 to the rotational shaft 3.

### Configuration of Container of Stirring Device According to One Embodiment of Present Disclosure

The container 2 is provided with a charging port 5 for charging the contents to be stirred by the stirring device 1 into the container 2 and a discharging port 6 for discharging the contents from the container 2. The charging port 5 has a charging hole 5a formed in the container 2, a tubular charging cylinder 5b connected at one end to the container 2 so as to surround the charging hole 5a, and an opening/closing member 5c, such as a lid or valve, configured to open and close the opening at the other end of the charging cylinder 5b. The discharging port 6 has a discharging hole 6a formed in the container 2, a tubular discharging cylinder 6b connected at one end to the container 2 so as to surround the discharging hole 6a, and an opening/closing member 6c, such as a lid or valve, configured to open and close the opening at the other end of the discharging cylinder 6b.

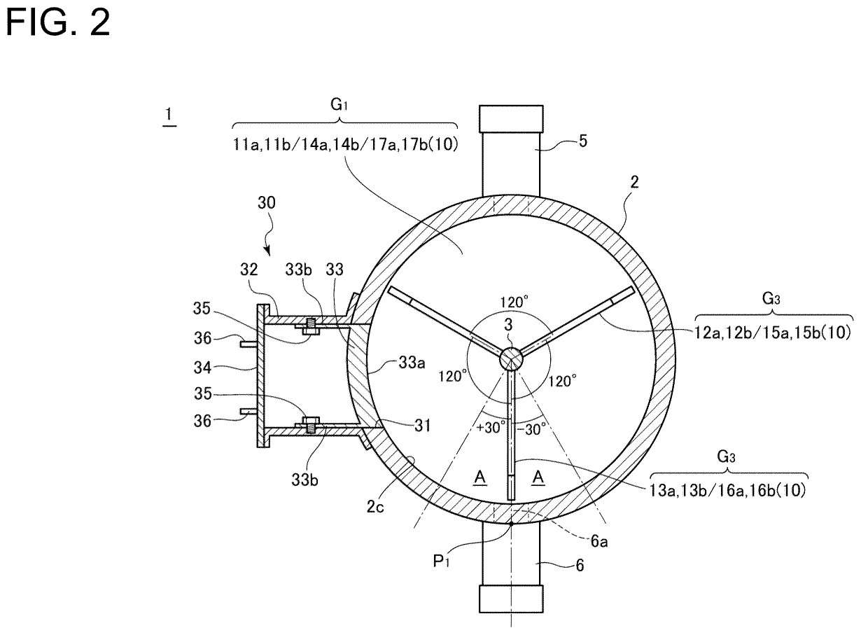

In FIG. 1, the charging port 5 and the discharging port 6 are depicted as being in the same horizontal position, but they may be in different horizontal positions. Regarding the discharging hole 6a, when the length of the container 2 from one end 2a to the other end 2b in the length direction of the rotational shaft 3 is defined as the length of the container 2, the discharging hole 6a is preferably formed in the range of 25% to 75% of the length of the container 2 from the end 2a toward the end 2b; most preferably the discharging hole 6a is formed in the middle between the ends 2a and 2b in the length direction of the rotational shaft 3 (i.e., in the 50% position of the length of the container 2 from the end 2a toward the end 2b in the length direction of the rotational shaft 3). Further, as shown in FIG. 2, the discharging hole 6a is preferably formed in the range A of −30°to +30°in the circumferential direction around the rotational shaft 3 from the lowest vertical position P₁ of the container 2. With this configuration, when the contents are discharged through the discharging hole 6a, the risk of the contents bridging and blocking the discharging hole 6a can be suppressed.

The container 2 may be provided with a manhole 30 for workers and maintenance equipment to enter the container 2 for maintenance. The manhole 30 has a manhole opening 31 formed in the container 2, a cylindrical member 32 fixed at one end to the container 2 so as to surround the manhole opening 31, an inner lid member 33 removably attached to the inside of the cylindrical member 32, and a lid member 34 that can open and close to cover the opening at the other end of the cylindrical member 32. The inner lid member 33 has an inner lid surface 33a that forms the same curved surface as an inner wall surface 2c of the container 2 when attached to the inside of the cylindrical member 32, and a cylindrical attachment part 33b that is located coaxially with the cylindrical member 32 when attached to the inside of the cylindrical member 32. By fixing the attachment part 33b to the cylindrical member 32 with a fastening member 35, such as bolts, the inner lid member 33 is fixed inside the cylindrical member 32. The lid member 34 may be provided with a handle 36 to open and close the lid member 34.

When workers enter the container 2 through the manhole 30 for maintenance, etc., the lid member 34 is opened, the fastening member 35 is removed in the cylindrical member 32, and the inner lid member 33 is unfastened from the cylindrical member 32. When the inner lid member 33 is removed through the opening at the other end of the cylindrical member 32, the outside and inside of the container 2 communicate through the cylindrical member 32, allowing workers to enter the container 2 through the opening at the other end of the cylindrical member 32. After maintenance, etc., is completed, the inner lid member 33 is inserted into the cylindrical member 32 from the opening at the other end of the cylindrical member 32, and the inner lid member 33 is fixed to the cylindrical member 32 with the fastening member 35. Finally, the lid member 34 is closed to close the manhole 30.

The manhole opening 31 has a step relative to the inner wall surface 2c of the container 2. Therefore, when the contents are stirred by the stirring blade 10, excessive torque may be generated due to the contents being caught between the stirring blade 10 and the step, which may damage the stirring blade 10. In contrast, the above configuration of the manhole 30 eliminates the step formed in the manhole opening 31 by the inner lid surface 33a, thus reducing the risk of damage to the stirring blade 10.

The stirring device 1 is not limited to a device that simply stirs and mixes the contents, but may be a reactor in which chemical reactions occur. If the stirring device 1 is a reactor, a jacket may be provided on the outer surface of the container 2 that constitutes a path for a liquid or vapor heating medium to circulate in order to regulate the temperature inside the container 2. In this case, the temperature inside the container 2 can be regulated by heat exchange between the heating medium and the contents or gases inside the container 2 as the heating medium flows through the path in the jacket.

The reactor as the stirring device 1 may be a hydrothermal treatment device for hydrolyzing waste as the contents. In this case, as shown in FIG. 1, the container 2 is provided with a supply port 7 to supply steam into the container 2 and an exhaust port 8 to exhaust the gas from the container 2. In FIG. 1, three supply ports 7 and three exhaust ports 8 are provided, but the number of each can optionally be changed.

### Configuration of Stirring Blade of Stirring Device According to One Embodiment of Present Disclosure

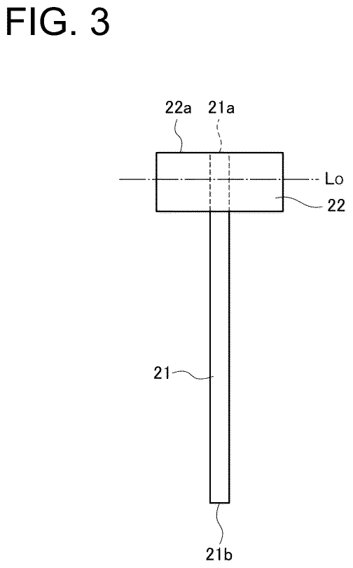

Next, the configuration of the at least one, preferably two or more, stirring blades 10 fixed to the rotational shaft 3 will be described. As shown in FIG. 3, the stirring blade 10 includes a support rod 21 fixed to the rotational shaft 3 (see FIG. 1) and a blade part 22 attached to the support rod 21. The blade part 22 extends so as to have a longitudinal axis Lo intersecting the length direction of the support rod 21. The blade part 22 is preferably provided at one end 21a of the support rod 21, for example, so that one end 21a of the support rod 21 is located on a tip surface 22a of the blade part 22.

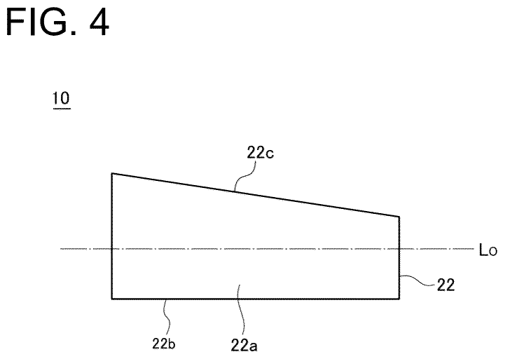

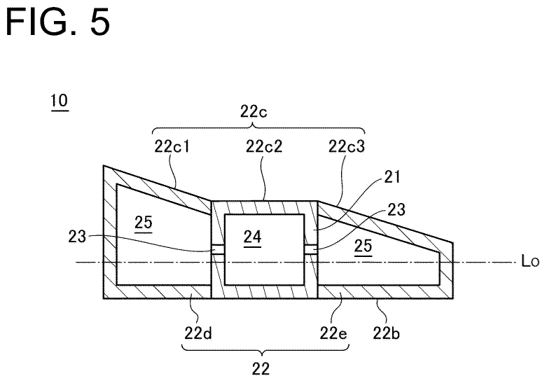

As shown in FIG. 4, the blade part 22 may include two surfaces 22b, 22c, with one surface 22c inclined with respect to the other surface 22b, and the thickness of the blade part 22 may decrease from one side to the other side along the longitudinal axis Lo. In FIG. 4, the tip surface 22a is trapezoidal, but it may be triangular, especially right-angled triangular. FIG. 4 shows a configuration in which the whole one surface 22c is inclined with respect to the other surface 22b, but it is not limited to this configuration. For example, as shown in FIG. 5, the blade part 22 may be configured such that two portions constituting the blade part 22, specifically, a first portion 22d and a second portion 22e, are fixed to the support rod 21 of rectangular shape so as to sandwich the support rod 21. If one surface 22c1, 22c3 of each of the first portion 22d and the second portion 22e is inclined with respect to the other surface 22b of the blade part 22, it means that the blade part 22 has a configuration in which only a part of one surface 22c, specifically, the surfaces 22c1 and 22c3 excluding the surface 22c2 of the rectangular support rod 21, is inclined with respect to the other surface 22b. That is, the blade part 22 may include a portion where at least a part of one surface is inclined with respect to the other surface, and the thickness of the blade part 22 may decrease from one side to the other side along the longitudinal axis L₀ in this portion.

As shown in FIG. 5, the support rod 21 may have a tubular shape including a first cavity portion 24 therein, and the blade part 22 may include a second cavity portion 25 defined between the two surfaces 22b, 22c, and the stirring blade 10 may be configured with one end 21a (see FIG. 3) of the support rod 21 inserted into the second cavity portion 25. With this configuration, the weight of the stirring blade 10 can be reduced compared to the case where the support rod 21 and the blade part 22 are solid, and as a result, the power consumption of the motor 4 (see FIG. 1) for rotating the rotational shaft 3 (see FIG. 1) to which the stirring blade 10 is fixed can be reduced.

In the case where the support rod 21 and the blade part 22 each have a hollow structure, at least one hole 23 may be formed in the support rod 21 to provide communication between the first cavity portion 24 and the second cavity portion 25. As in the case where the stirring device 1 (see FIG. 1) is for example a reactor, if the inside of the container 2 (see FIG. 1) becomes hot, the stirring blade 10 also becomes hot. As a result, the air in the first cavity portion 24 and the second cavity portion 25 is heated, and the pressure in the first cavity portion 24 and the second cavity portion 25 increases. Differences in the temperature of the air in the first cavity portion 24 and the second cavity portion 25 may lead to differences in the pressure in the first cavity portion 24 and the second cavity portion 25, which may cause the support rod 21 or the blade part 22 to deform due to pressure differences. In contrast, the hole 23 allows air exchange between the first cavity portion 24 and the second cavity portion 25 to keep the pressure in the first cavity portion 24 and the second cavity portion 25 the same, thus suppressing the deformation of the support rod 21 or the blade part 22 due to pressure differences.

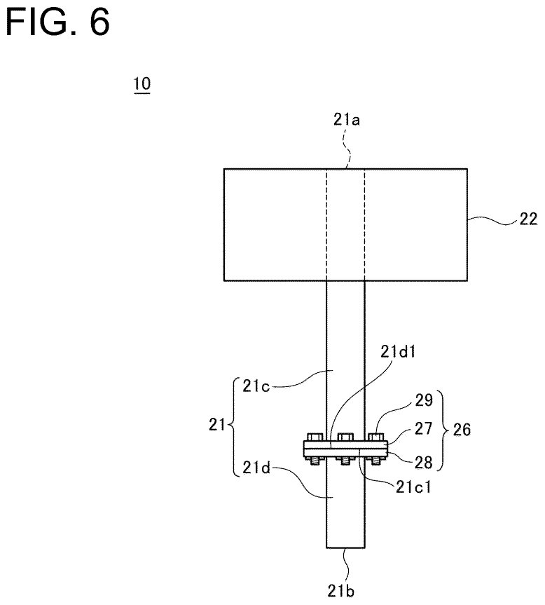

For example, as shown in FIG. 6, the support rod 21 may include a fixed part 26 which releasably fixes a tip part 21c including one end 21a of the support rod 21 and provided with the blade part 22 to a base part 21d including the other end 21b of the support rod 21. The fixed part 26 includes, for example, a flange 27 provided around the end 21c1 of the tip part 21c opposite the end 21a, a flange 28 provided around the end 21d1 of the base part 21d opposite the end 21b, and a fastening member 29 such as bolts. By fastening the flange 27 and the flange 28 with the fastening member 29, the tip part 21c and the base part 21d can be releasably fixed.

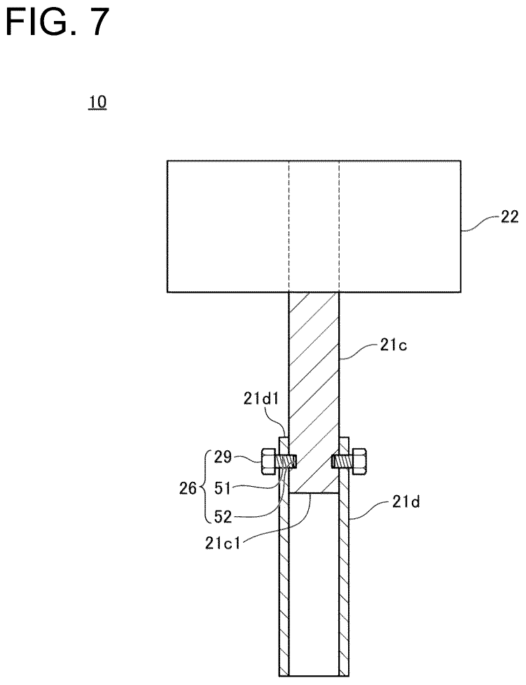

For example, as shown in FIG. 7, a portion of the tip part 21c including the end 21c1 may be inserted into the base part 21d of hollow shape through the opening at the end 21d1 of the base part 21d, and the base part 21d and the tip part 21c may be fastened by the fastening member 29 such as bolts to releasably fix the tip part 21c to the base part 21d. In this case, the fixed part 26 is composed of the fastening member 29 and holes 51, 52 formed in the base part 21d and the tip part 21c, respectively, for the fastening member 29. It is also possible to insert a portion of the base part 21d including the end 21d1 into the tip part 21c of hollow shape through the opening at the end 21c1 of the tip part 21c. However, the configurations of FIGS. 6 and 7 are only exemplary configurations of the fixed part 26, and any configuration of the fixed part 26 is acceptable as long as the tip part 21c and the base part 21d can be releasably fixed.

Compared to the base part 21d, the tip part 21c, which includes the blade part 22 to be hit by the contents stirred by the stirring blade 10, is more susceptible to damage. Therefore, with this configuration, when the tip part 21c is damaged, the stirring blade 10 can be efficiently repaired by separating the tip part 21c from the base part 21d and attaching a new or repaired tip part to the base part 21d.

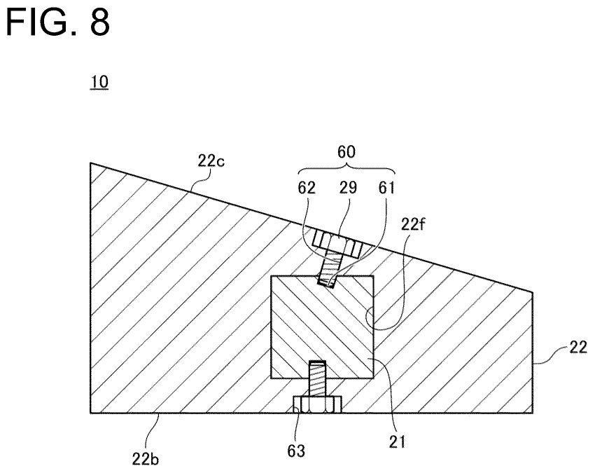

For this purpose, the configuration is not limited to one where the support rod 21 can be separated into the tip part 21c and the base part 21d, but a configuration where the support rod 21 can be separated from the blade part 22 is also possible. In other words, the stirring blade 10 may include a fixed part 60 (specific examples are shown in FIGS. 8 to 12 below) which releasably fixes the support rod 21 to the blade part 22. Compared to the support rod 21, the blade part 22 to be hit by the contents stirred by the stirring blade 10 is more susceptible to damage. Therefore, when the blade part 22 is damaged, the stirring blade 10 can be efficiently repaired if the blade part 22 can be separated from the support rod 21 and a new or repaired blade part can be attached to the support rod.

For example, as shown in FIG. 8, an insertion hole 22f may be formed in the blade part 22 into which the support rod 21 can be inserted, and the support rod 21 and the blade part 22 may be releasably fixed by the fastening member 29 such as bolts while the support rod 21 is inserted into the insertion hole 22f. In this case, the fixed part 60 which releasably fixes the support rod 21 to the blade part 22 is composed of the fastening member 29 and holes 61, 62 formed in the support rod 21 and the blade part 22, respectively, for the fastening member 29. In addition, when the holes 62 are formed in the surfaces 22b, 22c, depressions 63 may be formed in the surfaces 22b, 22c to accommodate the heads of bolts, which are examples of the fastening member 29, so that the heads of the bolts do not protrude from the surfaces 22b, 22c, preferably so that the heads of the bolts are flush with the surfaces 22b, 22c.

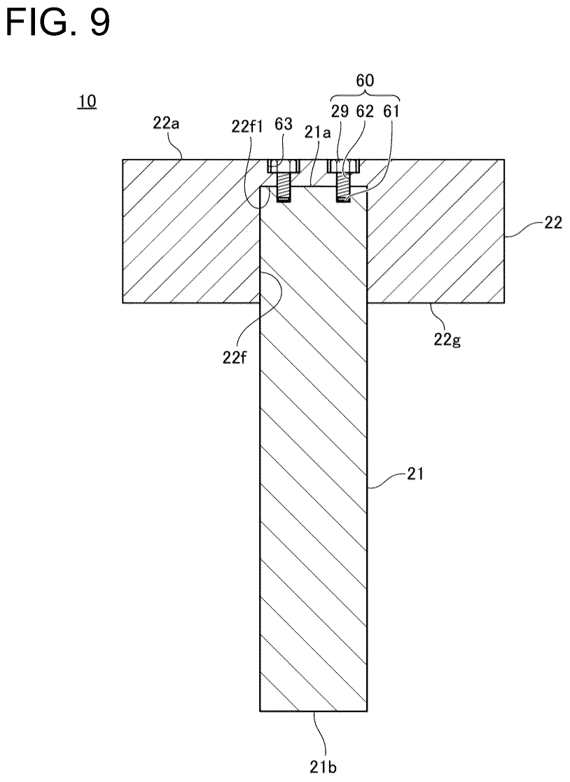

For example, as shown in FIG. 9, the insertion hole 22f into which the support rod 21 is inserted is formed in the blade part 22 so that it extends from a base surface 22g of the blade part 22 toward a tip surface 22a, and the insertion hole 22f is open at the base surface 22g and not open at the tip surface 22a. The support rod 21 is inserted into the insertion hole 22f with the end 21a of the support rod 21 touching an end surface 22f1 of the insertion hole 22f. To fix this condition, the support rod 21 and the blade part 22 may be releasably fixed by the fastening member 29 such as bolts from the tip surface 22a. In this case, the fixed part 60 which releasably fixes the support rod 21 to the blade part 22 is composed of the fastening member 29 and holes 61, 62 formed in the support rod 21 and the blade part 22, respectively, for the fastening member 29. Depressions 63 may be formed in the tip surface 22a to accommodate the heads of bolts, which are examples of the fastening member 29, so that the heads of the bolts do not protrude from the tip surface 22a, preferably so that the heads of the bolts are flush with the tip surface 22a.

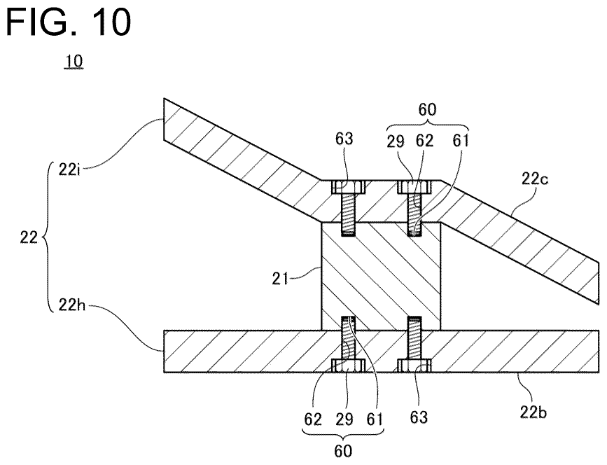

For example, as shown in FIG. 10, the blade part 22 may include two plate members 22h, 22i, and the support rod 21 and the blade part 22 (plate members 22h, 22i) may be releasably fixed by the fastening member 29 such as bolts while the support rod 21 is sandwiched between the two plate members 22h, 22i. In this case, the fixed part 60 which releasably fixes the support rod 21 to the blade part 22 is composed of the fastening member 29 and holes 61, 62 formed in the support rod 21 and the plate members 22h, 22i, respectively, for the fastening member 29. Depressions 63 may be formed in each of the plate members 22h, 22i to accommodate the heads of bolts, which are examples of the fastening member 29, so that the heads of the bolts do not protrude from the surfaces 22b, 22c, preferably so that the heads of the bolts are flush with the surfaces 22b, 22c.

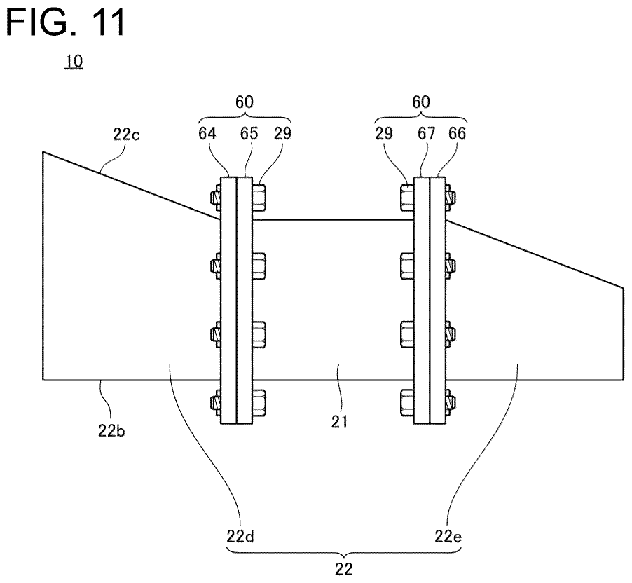

For example, as shown in FIG. 11, the blade part 22 may include two portions, i.e., a first portion 22d and a second portion 22e, and the support rod 21 and the blade part 22 may be releasably fixed by the fastening member 29 such as bolts while the support rod 21 is sandwiched between the first portion 22d and the second portion 22e. In this case, the fixed part 60 which releasably fixes the support rod 21 to the blade part 22 is composed of flanges 64 and 65 respectively disposed on the first portion 22d and the support rod 21 and facing each other, flanges 66 and 67 respectively disposed on the second portion 22e and the support rod 21 and facing each other, and the fastening member 29 such as bolts to fasten the flanges 64 and 65 together and the flanges 66 and 67 together. By fastening the flanges 64 and 65 together and the flanges 66 and 67 together by the fastening member 29, each of the first portion 22d and the support rod 21 is fixed to the support rod 21, and thus the support rod 21 and the blade part 22 are fixed. By removing the fastening member 29 and separating the flanges 64, 65 as well as the flanges 66, 67, each of the first portion 22d and the support rod 21 is separated from the support rod 21, and thus the support rod 21 and the blade part 22 are separated.

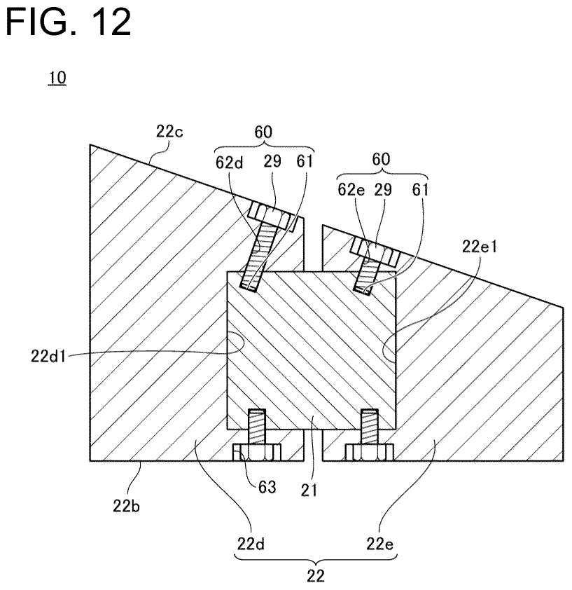

For example, as shown in FIG. 12, the blade part 22 may include two portions, i.e., a first portion 22d and a second portion 22e, the first portion 22d and the second portion 22e may have depressions 22d1 and 22e1, respectively, into which the support rod 21 can be fitted, and the support rod 21 and the blade part 22 may be releasably fixed by the fastening member 29 such as bolts while the support rod 21 is sandwiched between the first portion 22d and the second portion 22e so that the support rod 21 is fitted into the depressions 22d1 and 22e1. In this case, the fixed part 60 which releasably fixes the support rod 21 to the blade part 22 is composed of the fastening member 29, holes 61 formed in the support rod 21 for the fastening member 29, and holes 62d, 62e formed in the first portion 22d and the second portion 22e, respectively, for the fastening member 29. In addition, depressions 63 may be formed in the surfaces 22b, 22c to accommodate the heads of bolts, which are examples of the fastening member 29, so that the heads of the bolts do not protrude from the surfaces 22b, 22c, preferably so that the heads of the bolts are flush with the surfaces 22b, 22c.

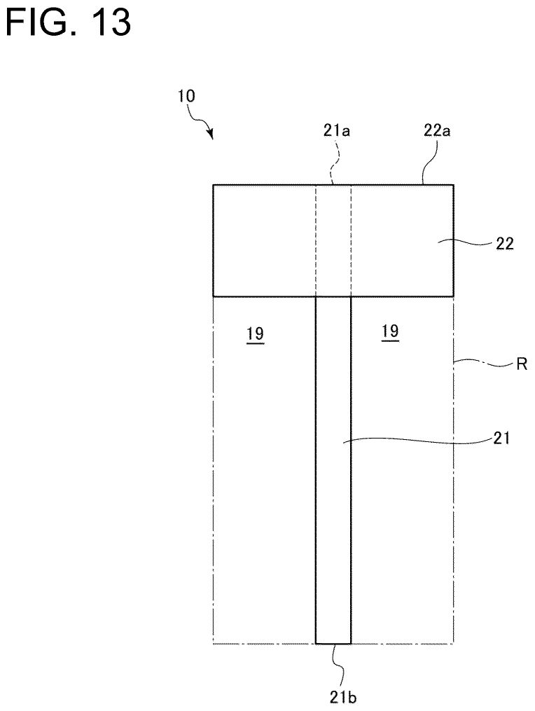

As shown in FIG. 13, define a hypothetical rectangle R that includes the other end 21b of the support rod 21 and the tip surface 22a of the blade part 22 along its edges. The stirring blade 10 preferably has a configuration in which the area of an opening portion 19, which is the portion of the rectangle R that is not occupied by the support rod 21 and the blade part 22, is 40 to 60% of the area of the rectangle R. This configuration allows the relatively large size of the contents stirred by the stirring blade 10 to pass through the opening portion 19, improving the mixing of the contents. Further, since the contents can pass through the opening portion 19, it is possible to reduce excessive stress on the stirring blade 10 due to the contents.

FIG. 1 shows a configuration in which a plurality of the stirring blades 10 are fixed to the rotational shaft 3. The support rod 21 (see FIG. 3) is fixed to the rotational shaft 3 so that each blade part 22 (see FIG. 3) of each stirring blade 10 is spaced away from the rotational shaft 3. When each stirring blade 10 has the configuration shown in FIG. 4 or 5, each stirring blade is disposed in a position where the blade part 22 (see FIG. 3) does not overlap the discharging hole 6a during rotation of the stirring blade 10. More specifically, the plurality of stirring blades 10, illustratively depicted in FIG. 1, includes stirring blades 11a, 12a, 13a, 14a, 15a, 16a, 17a, which are located on the side adjacent to one end 2a of the container 2 with respect to the discharging hole 6a, and stirring blades 11b, 12b, 13b, 14b, 15b, 16b, 17b, which are located on the side adjacent to the other end 2b of the container 2 with respect to the discharging hole 6a.

In such a configuration, each of the plurality of stirring blades 10 should be arranged so that the thickness of the blade part 22 (see FIG. 3) decreases toward the discharging hole 6a in the length direction of the rotational shaft 3. For example, in FIG. 1, the stirring blades 11a to 17a on the side adjacent to one end 2a of the container 2 with respect to the discharging hole 6a are arranged so that the thickness of their blade part 22 decreases toward the right, and the stirring blades 11b to 17b on the side adjacent to the other end 2b of the container 2 with respect to the discharging hole 6a are arranged so that the thickness of their blade part 22 decreases toward the left. One surface 22b of the two surfaces 22b, 22c (see FIG. 4) of the blade part 22 is preferably parallel to the rotational shaft 3. The fact that the rotational shaft 3 of elongated shape and the surface 22c of planar shape are parallel means that the two do not intersect when the surface 22c is extended in any direction while maintaining its planar shape and the rotational shaft 3 is extended in its longitudinal direction. The effect of this configuration will become clear in the description of the operation below.

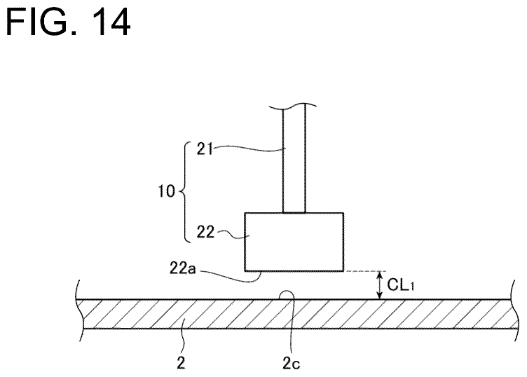

As shown in FIG. 14, the clearance CL₁ between the tip surface 22a of the blade part 22 and the inner wall surface 2c of the container 2 is preferably 20 to 50 mm. With this configuration, the contents are less likely to be caught between the blade part 22 and the inner wall surface 2c of the container 2, thus preventing locally large loads from being generated during stirring of the contents.

As shown in FIG. 1, a first distance is preferably smaller than a second distance, where the first distance is a distance between the rotational shaft 3 and the tip surface 22a (see FIG. 3) of the blade part 22 (see FIG. 3) of the stirring blade 17a, 17b closest to the end 2a, 2b of the container 2 in the length direction of the rotational shaft 3, and the second distance is a distance between the rotational shaft 3 and the tip surface 22a of the blade part 22 of another stirring blade 11a to 16a, 11b to 16b among the plurality of stirring blades 10. It is further preferred that the first distance be 85 to 95% of the second distance.

When the stirring blade 17a, 17b, which is closest to the end 2a, 2b of the container 2, stirs the contents, the stirred contents are pressed against the inner wall surface 2c at the end 2a, 2b of the container 2, so that the stirring blade 17a, 17b receives a load from the reaction against the compression of the contents. The longer the stirring blade 17a, 17b that receives this load, the greater the moment applied to the stirring blade 17a, 17b, and the more likely the stirring blade 17a, 17b is to be damaged. In contrast, by making the length of the stirring blade 17a, 17b shorter than the length of the other stirring blade 11a to 16a, 11b to 16b, the moment applied to the stirring blade 17a, 17b can be reduced, and a reduction in the service life of the stirring blade 17a and 17b can be suppressed. Further, by setting the length of the stirring blade 17a, 17b to 85 to 95% of the length of the stirring blade 11a to 16a, 11b to 16b, a reduction in the service life of the stirring blade 17a, 17b can be suppressed while minimizing a decrease in the stirring performance due to the short stirring blade 17a, 17b.

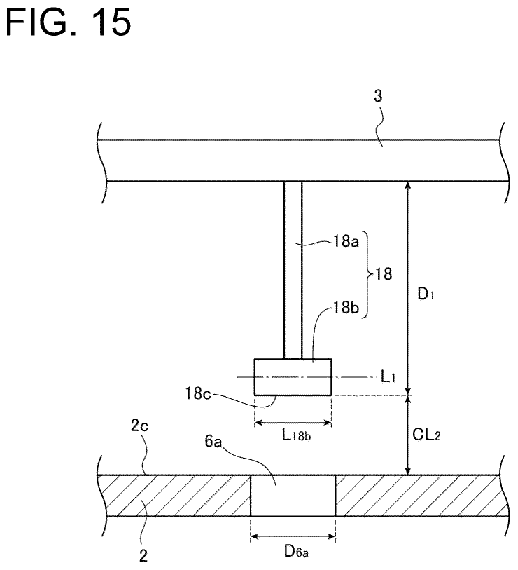

As shown in FIG. 1, a first stirring blade 18 may be fixed to the rotational shaft 3 in addition to the stirring blade 10. As shown in FIG. 15, the first stirring blade 18 includes a first support rod 18a fixed to the rotational shaft 3 and a first blade part 18b attached to the first support rod 18a. The first blade part 18b extends so as to have a longitudinal axis L₁ intersecting the length direction of the first support rod 18a. The first stirring blade 18 is disposed in a position where the first blade part 18b at least partially overlaps the discharging hole 6a during stirring. The distance D₁ from the rotational shaft 3 to a tip surface 18c of the first blade part 18b is preferably shorter than the distance from the rotational shaft 3 to the tip surface 22a (see FIG. 3) of the blade part 22 (see FIG. 3) of the stirring blade 10 (see FIG. 1). Further preferably, the clearance CL₂ between the first blade part 18b and the inner wall surface 2c of the container 2 is ⅓ to ⅔ of the diameter D₆ₐ of the discharging hole 6 a.

The discharging hole 6a has a step relative to the inner wall surface 2c of the container 2. Therefore, when the contents are stirred by the first stirring blade 18, excessive torque may be generated due to the contents being caught between the first blade part 18b and the step, which may damage the first stirring blade 18. In contrast, the first stirring blade 18 having the above configuration makes it difficult for the contents to be caught between the first blade part 18b and the step, thus reducing the risk of damage to the first stirring blade 18.

The length L_{18b} of the first blade part 18b along the longitudinal axis L₁ is preferably ⅔ to 3/2 of the diameter D₆ₐ of the discharging hole 6a. With this configuration, the contents can be efficiently pressed against the discharging hole 6a, so that the contents can be efficiently discharged from the container 2.

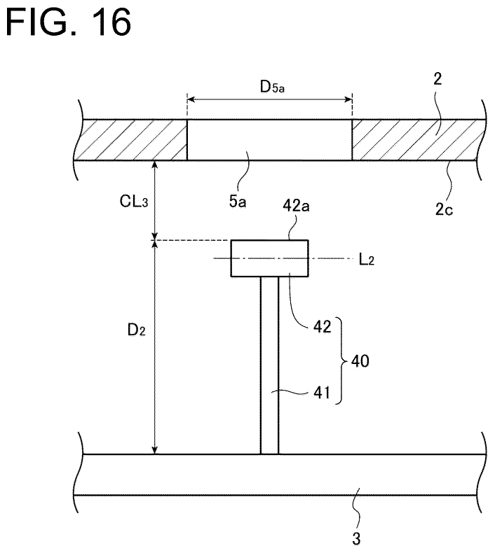

If the charging hole 5a (see FIG. 1) and the discharging hole 6a are disposed in different positions in the horizontal direction (the length direction of the rotational shaft 3), a second stirring blade 40, as shown in FIG. 16, may be fixed to the rotational shaft 3 in addition to the stirring blade 10 (see FIG. 1) and the first stirring blade 18 (see FIG. 1). The second stirring blade 40 includes a second support rod 41 fixed to the rotational shaft 3 and a second blade part 42 attached to the second support rod 41. The second blade part 42 extends so as to have a longitudinal axis L₂ intersecting the length direction of the second support rod 41. The second stirring blade 40 is disposed in a position where the second blade part 42 at least partially overlaps the charging hole 5a during stirring. The distance D₂ from the rotational shaft 3 to a tip surface 42a of the second blade part 42 is preferably shorter than the distance from the rotational shaft 3 to the tip surface 22a (see FIG. 3) of the blade part 22 (see FIG. 3) of the stirring blade 10 (see FIG. 1). Further preferably, the clearance CL₃ between the second blade part 42 and the inner wall surface 2c of the container 2 is ⅓ to ⅔ of the diameter D₅ₐ of the charging hole 5a.

The charging hole 5a has a step relative to the inner wall surface 2c of the container 2. Therefore, when the contents are stirred by the second stirring blade 40, excessive torque may be generated due to the contents being caught between the second blade part 42 and the step, which may damage the second stirring blade 40. In contrast, the second stirring blade 40 having the above configuration makes it difficult for the contents to be caught between the second blade part 42 and the step, thus reducing the risk of damage to the second stirring blade 40.

As shown in FIG. 1, when the rotational shaft 3 is divided into a first section 3a, which is on one side of the first stirring blade 18, and a second section 3b, which is on the other side of the first stirring blade 18, the same number of stirring blades 10 are fixed to each of the first section 3a and the second section 3b. For example, suppose that the first section 3a has seven stirring blades 11a to 17a and the second section 3b has seven stirring blades 11b to 17b. Considering a pair of stirring blades, with one provided in the first section 3a and the other in the second section 3b, specifically, stirring blades 11a and 11b, stirring blades 12a and 12b, stirring blades 13a and 13b, stirring blades 41a and 14b, stirring blades 16a and 16b, and stirring blades 17a and 17b, the number of stirring blades between one of the pair and the first stirring blade 18 is always the same as the number of stirring blades between the other of the pair and the first stirring blade 18. For example, taking the pair of stirring blades 15a, 15b as an example, the stirring blades 10 between the stirring blade 15a and the first stirring blade 18 are the four stirring blades 11a to 14a, and the stirring blades 10 between the stirring blade 15b and the first stirring blade 18 are the four stirring blades 11b to 14b.

As shown in FIG. 2, the pair of stirring blades is preferably fixed in positions that overlap when viewed along the length direction of the rotational shaft 3. Specifically, when viewed along the length direction of the rotational shaft 3, the pair of stirring blades 11a, 11b is in overlapping positions, the pair of stirring blades 12a and 12b is in overlapping positions, the pair of stirring blades 13a, 13b is in overlapping positions, the pair of stirring blades 14a, 14b is in overlapping positions, the pair of stirring blades 15a, 15b is in overlapping positions, the pair of stirring blades 16a, 16b is in overlapping positions, and the pair of stirring blades 17a, 17b is in overlapping positions. In FIG. 2, when the plurality of stirring blades 10 is viewed along the length direction of the rotational shaft 3, the plurality of stirring blades 10 appear to be divided into three groups G₁, G₂, and G₃, and the three groups are arranged in the circumferential direction around the rotational shaft 3, each offset by an angle of 120 degrees.

Instead of dividing the stirring blades 10 into three groups, they may be divided into four or more groups. For example, in a configuration where the stirring blades 10 are divided into four groups, these groups are arranged in the circumferential direction around the rotational shaft 3, each offset by an angle of 90 degrees. Furthe, the configuration is not limited to one where each group is offset by the same angle, but the angles between adjacent groups in the circumferential direction around the rotational shaft 3 may be different from one another.

### Operation of Stirring Device According to One Embodiment of Present Disclosure

As shown in FIG. 1, the contents to be stirred in the stirring device 1, e.g., waste in the case where the stirring device 1 is the above-described hydrothermal treatment device, is fed into the container 2 through the charging port 5. In the case where the stirring device 1 is the hydrothermal treatment device, steam is supplied into the container 2 through the supply port 7 to heat the waste in the container 2. When the motor 4 is started, the rotational shaft 3 rotates, which in turn rotates the stirring blade 10 and the first stirring blade 18 (or the second stirring blade 40 (see FIG. 16)) fixed to the rotational shaft 3, and the blade part 22 and the first blade part 18b (or the second blade part 42 (see FIG. 16)) of the stirring blade 10 and the first stirring blade 18 (or the second stirring blade 40) rotate around the rotational shaft 3 and along the inner wall surface 2c of the container 2. With the rotation of the blade part 22 and the first blade part 18b (or the second blade part 42), the contents are pushed by the blade parts and lifted along the inner wall surface 2c, eventually the contents fall therefrom, and then the contents are pushed again and lifted along the inner wall 2c; this operation is repeated. As a result, the contents are stirred by the stirring blade 10 and the first stirring blade 18 (or the second stirring blade 40) in the container 2.

In the case of the configuration as shown in FIG. 2, where each pair of stirring blades of the plurality of stirring blades 10 is fixed in positions that overlap when viewed along the length direction of the rotational shaft 3, in the operation described above, the contents are pushed by the blade parts 22 and lifted along the inner wall surface 2c, and even when the contents eventually fall from the blade parts 22, they are immediately pushed by the next pair of stirring blades and lifted along the inner wall surface 2c; this operation is repeated. In other words, when the contents pushed by the blade parts 22 of one pair of stirring blades fall from the blade parts 22, the blade parts 22 of another pair of stirring blades next to that pair of stirring blades pushes the contents again, and this operation is repeated, enabling the contents to be efficiently stirred.

Next, the preferred operation when the blade part 22 of the stirring blade 10 has the configuration shown in FIG. 4 or 5 will be described. In this case, it is preferred that the motor 4 be able to switch the direction of rotation of the rotational shaft 3. When stirring the contents in the container 2, the motor 4 rotates the rotational shaft 3 in the direction in which the surface 22b of the surfaces 22b and 22c of the blade part 22, which is parallel to the rotational shaft 3, pushes the contents. This prevents the contents from sliding off the surface 22b and allows the contents to be lifted to a relatively high position by the blade part 22, so that the contents are efficiently stirred. When stirring of the contents is finished and the contents are discharged through the discharging port 6, the motor 4 switches the direction of rotation of the rotational shaft 3 to the direction in which the surface 22c, which is not parallel to the rotational shaft 3, pushes the contents. Since the surface 22c is inclined with respect to the surface 22b, which is parallel to the rotational shaft 3, when the contents are pushed by the surface 22c, the contents move along the inclination of the surface 22c toward the discharging hole 6a in the length direction of the rotational shaft 3, so that the contents are collected in the discharging hole 6a. This allows switching between efficient stirring of the contents and efficient discharge of the contents from the container 2.

If the stirring device 1 is a hydrothermal treatment device, the organic components of waste are hydrolyzed during the above-described stirring operation. After the hydrolysis is completed, the gas components in the container 2 are discharged through the exhaust port 8 before the waste is discharged from the container 2. The waste is then discharged from the container 2 through the discharging port 6.

The contents described in the above embodiments would be understood as follows, for instance.
[1] A stirring blade according to one aspect includes: a support rod (21); and a blade part (22) attached to the support rod (21) and extending so as to have a longitudinal axis (L₀) in a direction intersecting a length direction of the support rod (21). The blade part (22) includes two opposite surfaces (22b, 22c), the blade part (22) at least partially includes a portion where one surface (22c) of the two surfaces (22b, 22c) is inclined with respect to the other surface (22b), and in said portion, a thickness of the blade part (22) decreases from one side to the other side along the longitudinal axis (L₀).

With the stirring blade of the present disclosure, by attaching the stirring blade such that one of the two surfaces of the blade part is inclined with respect to a rotational shaft to which the stirring blade is fixed, the contents in the stirring device move along the inclination of the one surface when stirring the contents by the stirring blade, and as a result, the contents can be moved in the direction along the rotational shaft. Therefore, if the discharging hole is positioned in the direction of movement of the contents, the contents can be efficiently discharged by rotating the stirring blade.
[2] A stirring blade according to another aspect is the stirring blade as defined in [1], where the support rod (21) has a tubular shape including a first cavity portion (24) therein, the blade part (22) includes a second cavity portion (25) defined between the two surfaces (22b, 22c), and one end (21a) of the support rod (21) is inserted into the second cavity portion (25).

With this configuration, the weight of the stirring blade can be reduced compared to the case where the support rod and the blade part are solid, and as a result, the power consumption of a rotating device for rotating the stirring blade can be reduced.
[3] A stirring blade according to another aspect is the stirring blade as defined in [2], where the support rod (21) has at least one hole (23), and the first cavity portion (24) communicates with the second cavity portion (25) through the at least one hole (23).

If the stirring blade is used in a hot container, the air in the first cavity portion and the second cavity portion is heated, and the pressure in the first cavity portion and the second cavity portion increases. Differences in the temperature of the air in the first cavity portion and the second cavity portion may lead to differences in the pressure in the first cavity portion and the second cavity portion, which may cause the support rod or the blade part to deform due to pressure differences. In contrast, with the configuration [3], the hole allows air exchange between the first cavity portion and the second cavity portion to keep the pressure in the first cavity portion and the second cavity portion the same, thus suppressing the deformation of the support rod or the blade part due to pressure differences.
[4] A stirring blade according to still another aspect is the stirring blade as defined in any one of [1] to [3], where the support rod (21) includes a fixed part (26) which releasably fixes a tip part (21c) including one end (21a) of the support rod (21) and provided with the blade part (22) to a base part (21d) including the other end (21b) of the support rod (21).

Compared to the base part, the tip part, which includes the blade part to be hit by the contents stirred by the stirring blade, is more susceptible to damage. Therefore, with the configuration [4], when the tip part is damaged, the stirring blade can be efficiently repaired by separating the tip part from the base part and attaching a new or repaired tip part to the base part.
[5] A stirring blade according to still another aspect is the stirring blade as defined in any one of [1] to [3], including a fixed part (60) which releasably fixes the support rod (21) to the blade part (22).

Compared to the support rod, the blade part to be hit by the contents stirred by the stirring blade is more susceptible to damage. Therefore, with the configuration [5], when the blade part is damaged, the stirring blade can be efficiently repaired by separating the blade part from the support rod and attaching a new or repaired blade part to the support rod.
[6] A stirring blade according to still another aspect is the stirring blade as defined in any one of [1] to [5], where a hypothetical rectangle (R) is defined by including the other end (21b) of the support rod (21) and a tip surface (22a) of the blade part (22) along edges of the rectangle (R), and an area of an opening portion (19), which is a portion of the rectangle (R) that is not occupied by the support rod (21) and the blade part (22), is 40 to 60% of an area of the rectangle (R).

With this configuration, the relatively large size of the contents stirred by the stirring blade can pass through the opening portion, so that the mixing of the contents is improved.
[7] A stirring device according to one aspect includes: a rotational shaft (3) mounted rotatably; at least one stirring blade (10) as defined in any one of [1] to [6] with the support rod (21) fixed to the rotational shaft (3) with a space between the blade part (22) and the rotational shaft (3); and a container (2) incorporating the at least one stirring blade (10).

The stirring device of the present disclosure having at least one stirring blade as defined in any one of [1] to [6] allows the contents to be efficiently from the container.
[8] A stirring device according to another aspect is the stirring device as defined in [7],where the container (2) has a discharging hole (6a) for discharging contents stirred by the stirring device (1) from the container (2). The at least one stirring blade (10) is disposed in a position where the blade part (22) does not overlap the discharging hole (6a) during stirring.

With this configuration, the contents can be moved toward the discharging hole by rotation of the stirring blade, so that the contents can be efficiently discharged from the container.
[9] A stirring device according to still another aspect is the stirring device as defined in [7] or [8], where the container (2) has a discharging hole (6a) for discharging contents stirred by the stirring device (1) from the container (2). The other surface (22b) of the blade part (22) of the at least one stirring blade (10) is parallel to the rotational shaft (3). A thickness of the blade part (22) of the at least one stirring blade (10) decreases toward the discharging hole (6a) in a length direction of the rotational shaft (3).

With this configuration, the contents can be moved toward the discharging hole by rotation of the stirring blade, so that the contents can be efficiently discharged from the container.
[₁₀] A stirring device according to still another aspect is the stirring device as defined in [9], including a rotating device (motor 4) configured to rotate the rotational shaft (3). The rotating device (4) is configured to be able to switch a direction of rotation of the rotational shaft (3).

With this configuration, by switching the direction of rotation of the rotational shaft, it is possible to switch between efficient stirring of the contents and efficient discharge of the contents from the container.
[11] A stirring device according to still another aspect is the stirring device as defined in any one of [7] to [₁₀], where the container (2) has a discharging hole (6a) for discharging contents stirred by the stirring device (1) from the container (2). The stirring device (1) includes a first stirring blade (18) that is separate from the at least one stirring blade (10). The first stirring blade (18) includes: a first support rod (18a) fixed to the rotational shaft (3); and a first blade part (18b) attached to the first support rod (18a) and extending so as to have a longitudinal axis (L₁) in a direction intersecting a length direction of the first support rod (18a). The first stirring blade (18) is disposed in a position where the first blade part (18b) at least partially overlaps the discharging hole (6a) during stirring. A distance (D₁) from the rotational shaft (3) to a tip surface (18c) of the first blade part (18b) is shorter than a distance from the rotational shaft (3) to a tip surface (22a) of the blade part (22).

The discharging hole has a step relative to the inner wall surface of the container. Therefore, when the contents are stirred by the first stirring blade, excessive torque may be generated due to the contents being caught between the first blade part and the step, which may damage the first stirring blade. In contrast, with the configuration [11], the contents are less likely to be caught between the first blade part and the step, so that the risk of damage to the first stirring blade is reduced.
[12] A stirring device according to still another aspect is the stirring device as defined in [11], where a clearance (CL₂) between the first blade part (18b) and an inner wall surface (2c) of the container (2) is ⅓ to ⅔ of a diameter (D₆ₐ) of the discharging hole (6a).

With this configuration, the contents are even less likely to be caught between the stirring blade and the step, so that the risk of damage to the stirring blade is further reduced.
[13] A stirring device according to still another aspect is the stirring device as defined in [11] or [12], where a length (L_{18b}) of the first blade part (18b) along the longitudinal axis (L₁) is ⅔ to 3/2 of a diameter (D₆ₐ) of the discharging hole (6a).

With this configuration, the contents can be efficiently pressed against the discharging hole, so that the contents can be efficiently discharged from the container.
[14] A stirring device according to still another aspect is the stirring device as defined in any one of [7] to [13], where the container (2) has a charging hole (5a) for charging contents to be stirred by the stirring device (1) into the container (2). The stirring device (1) includes a second stirring blade (40) that is separate from the at least one stirring blade (10). The second stirring blade (40) includes: a second support rod (41) fixed to the rotational shaft (3); and a second blade part (42) attached to the second support rod (41) and extending so as to have a longitudinal axis (L₂) in a direction intersecting a length direction of the second support rod (41). The second stirring blade (40) is disposed in a position where the second blade part (42) at least partially overlaps the charging hole (5a) during stirring. A distance (D₂) from the rotational shaft (3) to a tip surface (42a) of the second blade part (42) is shorter than a distance from the rotational shaft (3) to a tip surface (22a) of the blade part (22).

The charging hole has a step relative to the inner wall surface of the container. Therefore, when the contents are stirred by the stirring blade, excessive torque may be generated due to the contents being caught between the stirring blade and the step, which may damage the stirring blade. In contrast, with the configuration [14], the contents are less likely to be caught between the stirring blade and the step, so that the risk of damage to the stirring blade is reduced.
[15] A stirring device according to still another aspect is the stirring device as defined in [14], where a clearance (CL₃) between the second blade part (42) and an inner wall surface (2c) of the container (2) is ⅓ to ⅔ of a diameter (D₅ₐ) of the charging hole (5 a).

With this configuration, the contents are even less likely to be caught between the stirring blade and the step, so that the risk of damage to the stirring blade is further reduced.
[16] A stirring device according to still another aspect is the stirring device as defined in any one of [7] to [15], where a clearance (CL₁) between a tip surface (22a) of the blade part (22) and an inner wall surface (2c) of the container (2) is 20 to 50 mm.

With this configuration, the contents are less likely to be caught between the blade part and the inner wall surface of the container, thus preventing locally large loads from being generated during stirring of the contents.
[17] A stirring device according to still another aspect is the stirring device as defined in any one of [7] to [16], where the at least one stirring blade (10) includes at least two stirring blades (11a to 17a, 11b to 17b), and a first distance is smaller than a second distance, where the first distance is a distance between the rotational shaft (3) and a tip surface (22a) of the blade part (22) of a stirring blade (17a, 17b) closest to an end (2a, 2b) of the container (2) in a length direction of the rotational shaft (3), and the second distance is a distance between the rotational shaft (3) and a tip surface (22a) of the blade part (22) of another stirring blade (11a to 16a, 11b to 16b) among the at least two stirring blades (11a to 17a, 11b to 17b).

When the stirring blade closest to the end of the container stirs the contents, the stirred contents are pressed against the inner wall surface at the end of the container, so that the stirring blade receives a load from the reaction against the compression of the contents. The longer the stirring blade that receives this load, the greater the moment applied to the stirring blade, and the more likely the stirring blade is to be damaged. In contrast, with the configuration [17], the moment applied to the stirring blade closest to the end in the container can be reduced, and thus a reduction in the service life of this stirring blade can be suppressed.
[18] A stirring device according to still another aspect is the stirring device as defined in [17], where the first distance is 85 to 95% of the second distance.

With this configuration, a reduction in the service life of the stirring blade can be suppressed while minimizing a decrease in the stirring performance due to the short stirring blade closest to the end in the container.
[19] A stirring device according to still another aspect is the stirring device as defined in any one of [11] to [13], where the rotational shaft (3) is divided into a first section (3a) which is on one side of the first stirring blade (18) and a second section (3b) which is on the other side of the first stirring blade (18), the same number of stirring blades (11a to 17a/11b to 17b) are fixed to each of the first section (3a) and the second section (3b), and a pair of the stirring blades (11a, 11b/12a, 12b/13a, 13b/14a, 14b/15a, 15b/16a, 16b/17a, 17b), with one provided in the first section (3a) and the other in the second section (3b), is fixed in positions that overlap when viewed along a length direction of the rotational shaft (3), the number of stirring blades (10) between one (11a to 17a) of the pair of stirring blades and the first stirring blade (18) being the same as the number of stirring blades between the other (11b to 17b) of the pair of stirring blades and the first stirring blade (18).

With this configuration, when the contents pushed by the blade parts of one pair of stirring blades fall from the blade parts, the blade parts of another pair of stirring blades next to that pair of stirring blades pushes the contents again, and this operation is repeated, enabling the contents to be efficiently stirred.
[20] A stirring device according to still another aspect is the stirring device as defined in any one of [7] to [19], where the container (2) has a discharging hole (6a) for discharging contents to be stirred by the stirring device (1) from the container (2). When a length of the container (2) from one end (2a) to the other end (2b) in a length direction of the rotational shaft (3) is defined as a length of the container (2), the discharging hole (6a) is formed in a range of 25% to 75% of the length of the container (2) in the length direction of the rotational shaft (3) from one end (2a) of the container (2) toward the other end (2b) of the container (2), and in a range (A) of −30°to +30°in a circumferential direction around the rotational shaft (3) from a lowest vertical position (P₁) of the container (2).

With this configuration, when the contents are discharged through the discharging hole, the risk of the contents bridging and blocking the discharging hole can be suppressed.
[21] A stirring device according to still another aspect is the stirring device as defined in any one of [7] to [20], where the container has a manhole (30). The manhole (30) includes: a manhole opening (31) formed in the container (2); a cylindrical member (32) fixed at one end to the container (2) so as to surround the manhole opening (31); and an inner lid member (33) removably attached to inside of the cylindrical member (32). The inner lid member (33) has an inner lid surface (33a) that forms the same curved surface as an inner wall surface (2c) of the container (2) when attached to the inside of the cylindrical member (32).

The manhole opening has a step relative to the inner wall surface of the container. Therefore, when the contents are stirred by the stirring blade, excessive torque may be generated due to the contents being caught between the stirring blade and the step, which may damage the stirring blade. In contrast, the configuration [21] eliminates the step formed in the manhole opening by the inner lid surface, thus reducing the risk of damage to the stirring blade.
[22] A stirring device according to still another aspect is the stirring device as defined in [10], where when discharging the contents from the container (2), the rotating device (4) rotates the rotational shaft (3) in a direction in which the one surface (22c) pushes the contents.

With this configuration, the contents can be efficiently discharged from the container.
[23] A stirring device according to still another aspect is the stirring device as defined in [10], where when stirring the contents in the container (2), the rotating device (4) rotates the rotational shaft (3) in a direction in which the other surface (22b) pushes the contents.

With this configuration, the contents can be efficiently stirred in the container.

### REFERENCE SIGNS LIST

1 Stirring device
2 Container
2a End (of container 2)
2b End (of container 2)
2c Inner wall surface (of container 2)
3 Rotational shaft
3a First section (of rotational shaft 3)
3b Second section (of rotational shaft 3)
4 Motor (Rotating device)
5a Charging hole
6a Discharging hole
10 Stirring blade
11a to 17a Stirring blade (constituting stirring blade 10)
11b to 17b Stirring blade (constituting stirring blade 10)
18 First stirring blade
18a First support rod
18b First blade part
18c Tip surface (of first blade part 18b)
19 Opening portion
21 Support rod
22 Blade part
21a End (of support rod 21)
21b End (of support rod 21)
22a Tip surface (of blade part 22)
22b Surface (of blade part 22)
22c Surface (of blade part 22)
23 Hole
24 First cavity portion
25 Second cavity portion
26 Fixed part
30 Manhole
31 Manhole opening
32 Cylindrical member
33 Inner lid member
33a Inner lid surface
40 Second stirring blade
41 Second support rod
42 Second blade part
42a Tip surface (of second blade part 42)
60 Fixed part
L₀ longitudinal axis
L₁ longitudinal axis
L₂ longitudinal axis
R Rectangle

1. A stirring blade, comprising:
a support rod; and
a blade part attached to the support rod and extending so as to have a longitudinal axis in a direction intersecting a length direction of the support rod,
wherein the blade part includes two opposite surfaces, the blade part at least partially includes a portion where one surface of the two surfaces is inclined with respect to the other surface, and in said portion, a thickness of the blade part decreases from one side to the other side along the longitudinal axis.

2. The stirring blade according to claim 1,
wherein the support rod has a tubular shape including a first cavity portion therein, the blade part includes a second cavity portion defined between the two surfaces, and one end of the support rod is inserted into the second cavity portion.

3. The stirring blade according to claim 2,
wherein the support rod has at least one hole, and the first cavity portion communicates with the second cavity portion through the at least one hole.

4. The stirring blade according to claim 1,
wherein the support rod includes a fixed part which releasably fixes a tip part including one end of the support rod and provided with the blade part to a base part including the other end of the support rod.

5. The stirring blade according to claim 1, comprising a fixed part which releasably fixes the support rod to the blade part.

6. The stirring blade according to claim 1,
wherein a hypothetical rectangle is defined by including the other end of the support rod and a tip surface of the blade part along edges of the rectangle, and an area of an opening portion, which is a portion of the rectangle that is not occupied by the support rod and the blade part, is 40 to 60% of an area of the rectangle.

7. A stirring device, comprising:
a rotational shaft mounted rotatably;
at least one stirring blade according to claim 1 with the support rod fixed to the rotational shaft with a space between the blade part and the rotational shaft; and
a container incorporating the at least one stirring blade.

8. The stirring device according to claim 7,
wherein the container has a discharging hole for discharging contents stirred by the stirring device from the container, and
wherein the at least one stirring blade is disposed in a position where the blade part does not overlap the discharging hole during stirring.

9. The stirring device according to claim 7,
wherein the container has a discharging hole for discharging contents stirred by the stirring device from the container,
wherein the other surface of the blade part of the at least one stirring blade is parallel to the rotational shaft, and
wherein a thickness of the blade part of the at least one stirring blade decreases toward the discharging hole in a length direction of the rotational shaft.

10. The stirring device according to claim 9, comprising a rotating device configured to rotate the rotational shaft,
wherein the rotating device is configured to be able to switch a direction of rotation of the rotational shaft.

11. The stirring device according to claim 7,
wherein the container has a discharging hole for discharging contents stirred by the stirring device from the container,
wherein the stirring device includes a first stirring blade that is separate from the at least one stirring blade,
wherein the first stirring blade includes:
a first support rod fixed to the rotational shaft; and
a first blade part attached to the first support rod and extending so as to have a longitudinal axis in a direction intersecting a length direction of the first support rod,
wherein the first stirring blade is disposed in a position where the first blade part at least partially overlaps the discharging hole during stirring, and
wherein a distance from the rotational shaft to a tip surface of the first blade part is shorter than a distance from the rotational shaft to a tip surface of the blade part.

12. The stirring device according to claim 11,
wherein a clearance between the first blade part and an inner wall surface of the container is ⅓ to ⅔ of a diameter of the discharging hole.

13. The stirring device according to claim 11,
wherein a length of the first blade part along the longitudinal axis is ⅔ to 3/2 of a diameter of the discharging hole.

14. The stirring device according to claim 7,
wherein the container has a charging hole for charging contents to be stirred by the stirring device into the container,
wherein the stirring device includes a second stirring blade that is separate from the at least one stirring blade,
wherein the second stirring blade includes:
a second support rod fixed to the rotational shaft; and
a second blade part attached to the second support rod and extending so as to have a longitudinal axis in a direction intersecting a length direction of the second support rod,
wherein the second stirring blade is disposed in a position where the second blade part at least partially overlaps the charging hole during stirring, and
wherein a distance from the rotational shaft to a tip surface of the second blade part is shorter than a distance from the rotational shaft to a tip surface of the blade part.

15. The stirring device according to claim 14,
wherein a clearance between the second blade part and an inner wall surface of the container is ⅓ to ⅔ of a diameter of the charging hole.

16. The stirring device according to claim 7,
wherein a clearance between a tip surface of the blade part and an inner wall surface of the container is 20 to 50 mm.

17. The stirring device according to claim 7,
wherein the at least one stirring blade includes at least two stirring blades, and
wherein a first distance is smaller than a second distance, where the first distance is a distance between the rotational shaft and a tip surface of the blade part of a stirring blade closest to an end of the container in a length direction of the rotational shaft, and the second distance is a distance between the rotational shaft and a tip surface of the blade part of another stirring blade among the at least two stirring blades.

18. The stirring device according to claim 17,
wherein the first distance is 85 to 95% of the second distance.

19. The stirring device according to claim 11,
wherein the rotational shaft is divided into a first section which is on one side of the first stirring blade and a second section which is on the other side of the first stirring blade,
wherein the same number of stirring blades are fixed to each of the first section and the second section, and
wherein a pair of the stirring blades, with one provided in the first section and the other in the second section, is fixed in positions that overlap when viewed along a length direction of the rotational shaft, the number of stirring blades between one of the pair of stirring blades and the first stirring blade being the same as the number of stirring blades between the other of the pair of stirring blades and the first stirring blade.

20. The stirring device according to claim 7,
wherein the container has a discharging hole for discharging contents stirred by the stirring device from the container,
wherein a length of the container from one end to the other end in a length direction of the rotational shaft is defined as a length of the container, and
wherein the discharging hole is formed in a range of 25% to 75% of the length of the container in the length direction of the rotational shaft from one end of the container toward the other end of the container, and in a range of −30°to +30°in a circumferential direction around the rotational shaft from a lowest vertical position of the container.

21. The stirring device according to claim 7,
wherein the container has a manhole,
wherein the manhole includes:
a manhole opening formed in the container;
a cylindrical member fixed at one end to the container so as to surround the manhole opening; and
an inner lid member removably attached to inside of the cylindrical member,
wherein the inner lid member has an inner lid surface that forms the same curved surface as an inner wall surface of the container when attached to the inside of the cylindrical member.

22. The stirring device according to claim 10,
wherein when discharging the contents from the container, the rotating device rotates the rotational shaft in a direction in which the one surface pushes the contents.

23. The stirring device according to claim 10,
wherein when stirring the contents in the container, the rotating device rotates the rotational shaft in a direction in which the other surface pushes the contents.
